(19) United States
(12) Patent Application Publication
(10) Pub. No.: US 2025/0307667 A1
(43) Pub. Date: Oct. 2, 2025

(54) INFORMATION PROCESSING APPARATUS, INFORMATION PROCESSING METHOD, AND RECORDING MEDIUM

(71) Applicant: NEC Corporation, Tokyo (JP)

(72) Inventor: Yuichi YANO, Tokyo (JP)

(73) Assignee: NEC Corporation, Tokyo (JP)

(21) Appl. No.: 19/049,100

(22) Filed: Feb. 10, 2025

(30) Foreign Application Priority Data
Mar. 26, 2024 (JP) 2024-050252

(51) Int. Cl. G06N 5/022

(52) U.S. Cl. CPC G06N 5/022

(57) ABSTRACT

To attain the object of generating information useful in a decision-making situation with use of a knowledge graph and providing the information to a user, at least one processor included in an information processing apparatus executes a graph editing process of generating at least one second knowledge graph by making editing corresponding to each of assumptions with respect to a first knowledge graph (for example, knowledge graph which deals with issues concerning medical care), a link predicting process of calculating, with use of a link predicting technique, a score of a link corresponding to a conclusion in each of the at least one second knowledge graph, and an information generating process of generating, with reference to the score, information which indicates an influence that selection of an assumption has on the conclusion.

This application is based upon and claims the benefit of priority from Japanese patent application No. 2024-050252, filed on Mar. 26, 2024, the disclosure of which is incorporated herein in its entirety by reference.

### TECHNICAL FIELD

The present disclosure relates to an information processing apparatus, an information processing method, and a recording medium.

### BACKGROUND ART

As a technique for assisting a user in making a decision, knowledge graphs are used. Patent Literature 1 discloses “Graph AI” in which a patient and an attribute of the patient are linked with each other. Note, here, that AI refers to artificial intelligence.

### CITATION LIST

### Patent Literature

### [Patent Literature 1]

Pamphlet of International Publication NO. 2023/188800

### SUMMARY OF INVENTION

### Technical Problem

In a decision-making situation, it is useful to know how selection regarding an assumption (for example, which one of a plurality of assumptions is employed or whether or not a single assumption is employed) influences a conclusion. However, a technique of generating such information and providing the information to a user has not been realized yet.

The present disclosure has been made in view of the above problem, and an example object thereof is to realize a technique of generating information useful in a decision-making situation with use of a knowledge graph and providing the information to a user.

### Solution to Problem

An information processing apparatus in accordance with an example aspect of the present disclosure includes at least one processor, the at least one processor executing: a graph editing process of generating at least one second knowledge graph by making editing corresponding to each of at least one assumption with respect to a first knowledge graph which includes nodes that each represent an object and links that each represent a relation between objects; a link predicting process of calculating, with use of a link predicting technique, a score of a link corresponding to a conclusion in each of the at least one second knowledge graph which has been generated in the graph editing process; and an information generating process of generating information which indicates an influence that selection regarding the at least one assumption has on a possibility that the conclusion is derived, with reference to at least one score which has been calculated in the link predicting process.

An information processing method in accordance with an example aspect of the present disclosure includes: a graph editing process of generating at least one second knowledge graph by making editing corresponding to each of at least one assumption with respect to a first knowledge graph which includes nodes that each represent an object and links that each represent a relation between objects; a link predicting process of calculating, with use of a link predicting technique, a score of a link corresponding to a conclusion in each of the at least one second knowledge graph which has been generated in the graph editing process; and an information generating process of generating information which indicates an influence that selection regarding the at least one assumption has on a possibility that the conclusion is derived, with reference to at least one score which has been calculated in the link predicting process, the graph editing process, the link predicting process, and the information generating process being carried out by at least one processor.

A recording medium in accordance with an example aspect of the present disclosure is a non-transitory recording medium in which an information processing program is recorded, the information processing program causing at least one processor to execute: a graph editing process of generating at least one second knowledge graph by making editing corresponding to each of at least one assumption with respect to a first knowledge graph which includes nodes that each represent an object and links that each represent a relation between objects; a link predicting process of calculating, with use of a link predicting technique, a score of a link k corresponding to a conclusion in each of the at least one second knowledge graph which has been generated in the graph editing process; and an information generating process of generating information which indicates an influence that selection regarding the at least one assumption has on a possibility that the conclusion is derived, with reference to at least one score which has been calculated in the link predicting process.

### Advantageous Effects of Invention

An example aspect of the present disclosure makes it possible to generate information useful in a decision-making situation with use of a knowledge graph and provide the information to a user.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

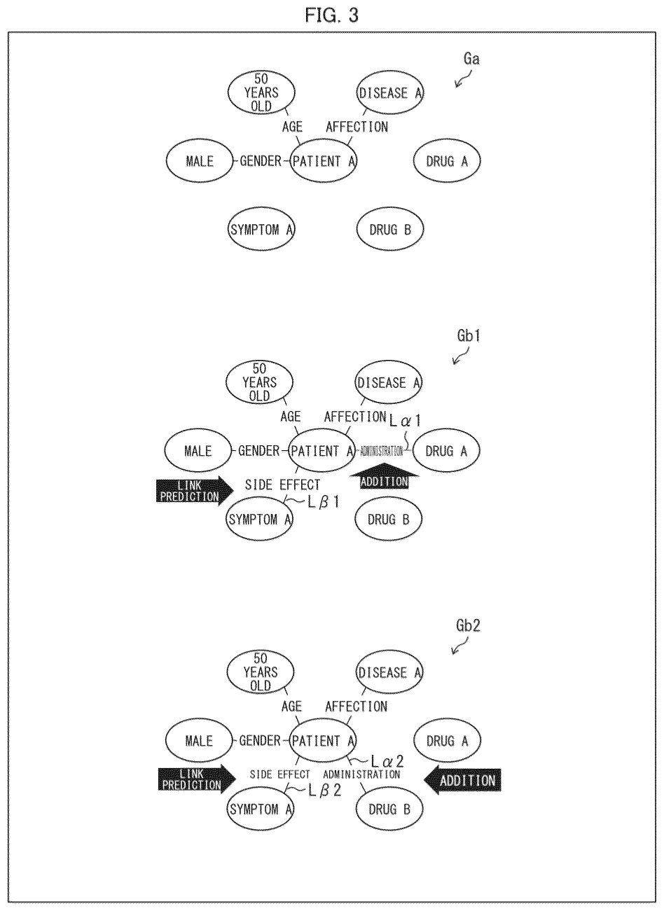

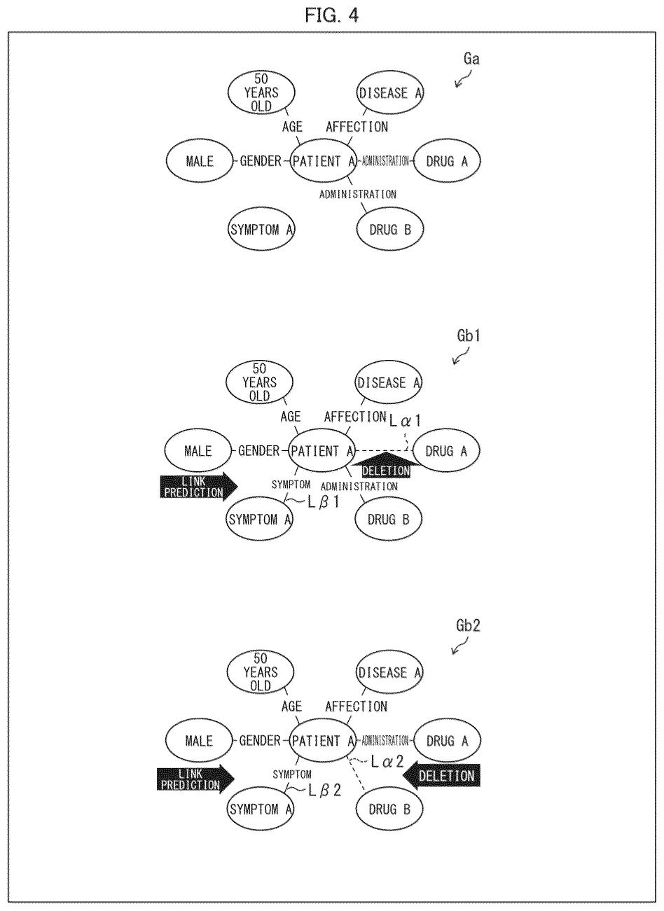

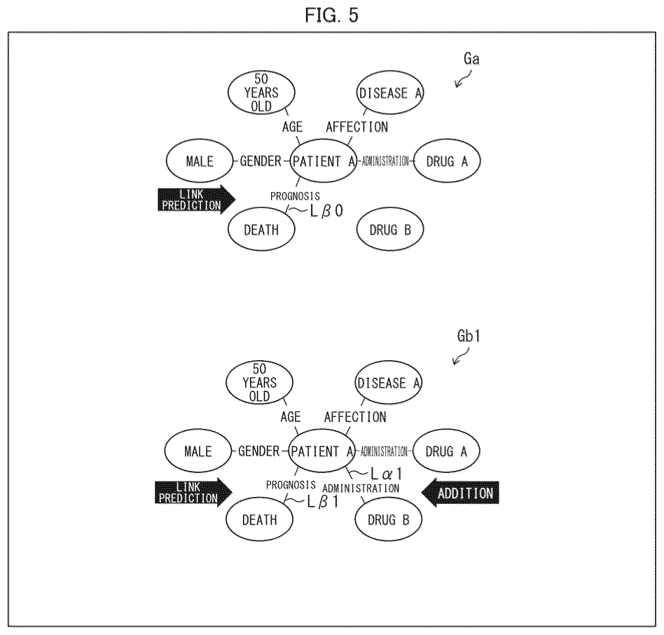

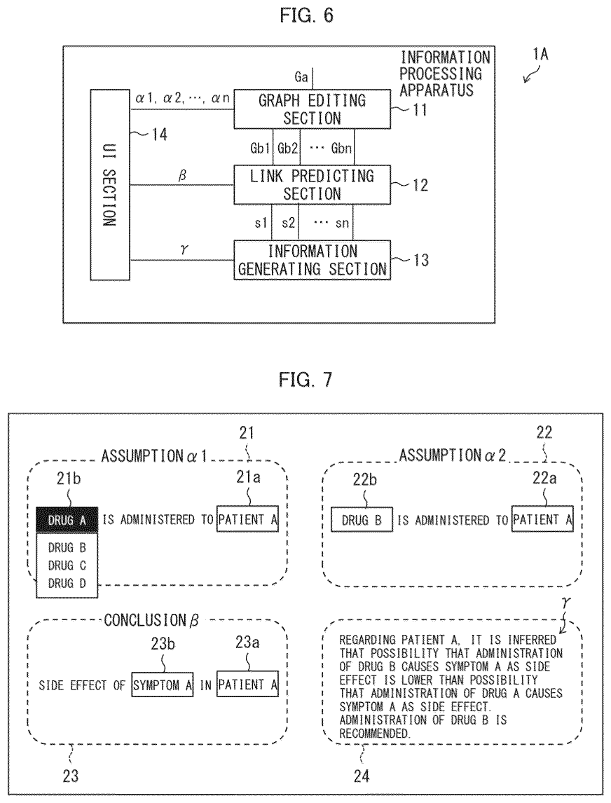

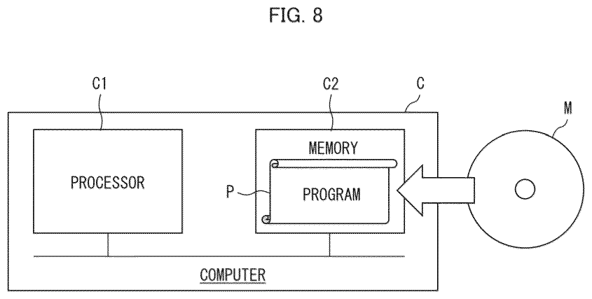

An upper part of FIG. 3 illustrates, as an example, a part of a first knowledge graph used in the information processing method illustrated in FIG. 2. A middle part and a lower part of FIG. 3 each illustrate, as an example, a part of a second knowledge graph used in the information processing method illustrated in FIG. 2.

An upper part of FIG. 4 illustrates, as an example, a part of a first knowledge graph used in the information processing method illustrated in FIG. 2. A middle part and a lower part of FIG. 4 each illustrate, as an example, a part of a second knowledge graph used in the information processing method illustrated in FIG. 2.

An upper part of FIG. 5 illustrates, as an example, a part of a first knowledge graph used in the information processing method illustrated in FIG. 2. A lower part of FIG. 5 illustrates, as an example, a part of a second knowledge graph used in the information processing method illustrated in FIG. 2.

FIG. 6 is a block diagram illustrating a configuration of an information processing apparatus in accordance with the present disclosure.

FIG. 7 illustrates an example of a screen which the information processing apparatus illustrated in FIG. 6 causes to be displayed on a display.

FIG. 8 is a block diagram illustrating a hardware configuration of a computer which functions as each information processing apparatus in accordance with the present disclosure.

### DESCRIPTION OF EMBODIMENTS

The following description will 1 discuss example embodiments of the present invention. Note, however, that the present invention is not limited to the example embodiments described below, but may be altered in various ways by a skilled person within the scope of the claims. For example, the present invention can also encompass, in its scope, any example embodiment derived by appropriately combining techniques (some or all of products or methods) employed in the example embodiments described below. Further, the present invention can also encompass, in its scope, any example embodiment derived by appropriately omitting a part of a technique employed in each of the example embodiments described below. Further, the effects mentioned in the example embodiments described below are examples of the effects expected in the example embodiments described below, and are not intended to define an extension of the present invention. That is, the present invention can also encompass, in its scope, any example embodiment that does not bring about any of the effects mentioned in the example embodiments described below.

### Definitions of Terms

### (Knowledge Graph)

In the present disclosure, the term “knowledge graph” refers to a graph which is constituted by a set of nodes that each represent an object (hereinafter, also referred to as “node set”) and a set of links that each represent a relation between objects (hereinafter, also referred to as “link set”). In a case where a certain relation exists between any two objects, two nodes that represent the respective two objects are connected by a link that represents the relation. A knowledge graph which includes N objects and M types of links can be stored in a memory or processed by a processor as, for example, array data which is constituted by N×N elements that each take any one of M values.

The object which the nodes each represent and the relation which the links each represent can be set as desired in accordance with issues dealt with. For example, in a case where issues concerning medical care are dealt with, nodes that each represent a patient, nodes that each represent a gender, nodes that each represent an age, nodes that each represent a disease, nodes that each represent a symptom, nodes that each represent a pharmaceutical, and the like are, for example, used as the nodes. As the links, links that each represent a relation “gender”, links that each represent a relation “age”, links that each represent a relation “affection”, links that each represent a relation “onset”, links that each represent a relation “administration”, and the like are used.

For example, in a case where Ichiro Yamada is a 50-year-old male, a node that represents a patient “Ichiro Yamada” and a node that represents a gender “male” are connected by a link that represents a relation “gender”, and the node that represents the patient “Ichiro Yamada” and a node that represents an age “50 years old” are connected by a link that represents a relation “age”. In a case where Ichiro Yamada runs a fever, the node that represents the patient “Ichiro Yamada” and a node that represents a symptom “fever” are connected by a link that represents a relation “onset”. In a case where a patient “Hanako Kawabata” is a 45-year-old female, a node that represents a patient “Hanako Kawabata” and a node that represents a gender “female” are connected by a link that represents a relation “gender”, and the node that represents the patient “Hanako Kawabata” and a node that represents an age “45 years old” are connected by a link that represents a relation “age”. In a case where the patient “Hanako Kawabata” runs a fever, the node that represents the patient “Hanako Kawabata” and the node that represents the symptom “fever” are connected by a link that represents a relation “onset”. In this case, the node that represents the patient “Taro Yamada” and the node that represents the patient “Hanako Kawabata” are indirectly connected via the node that represents the symptom “fever”.

### (Link Predicting Technique)

In the present disclosure, a link predicting technique refers to a technique of making a prediction regarding a link included in a knowledge graph. For example, in a case where two nodes which are included in a node set and one link which is included in a link set are specified and the link predicting technique is applied to a knowledge graph, calculated is a score which indicates the degree of certainty that the two specified nodes are connected by the specified link. In the link predicting technique, a model which calculates a score (also referred to as “link predicting AI”) can be generated by machine learning. As an example, a technique of generating, by machine learning, a model into which features (for example, three features that respectively feature, a relation, and a represent a potential numerical feature) extracted from a knowledge model are inputted and which outputs a score is in practical use. Since such a link predicting technique is publicly known, further explanation is omitted in the present disclosure.

The link predicting technique assists a user in making a decision. Application of the link predicting technique to the foregoing knowledge graph which deals with the issues concerning the medical care enables, for example, the following. That is, in a case where the node that represents the patient “Ichiro Yamada” and a node that represents a disease “pneumonia” are specified and the link predicting technique is applied, it is possible to estimate a possibility that Ichiro Yamada is to be affected by pneumonia, from a score of a link that represents a relation “affection”. Alternatively, in a case where the node that represents the patient “Ichiro Yamada” and the node that represents the symptom “fever” are specified and the link predicting technique is applied, it is possible to estimate a possibility that Ichiro Yamada runs a fever, from a score of the link that represents the relation “onset”. In a case where the link predicting technique is applied to the foregoing knowledge graph which deals with the issues concerning the medical care, it is thus possible to assist a user (for example, a doctor) in making a diagnosis (for example, estimation of a disease or a symptom).

### First Example Embodiment

The following description will discuss a first example embodiment, which is an example of an embodiment of the present invention, in detail, with reference to the drawings. The present example embodiment is a basic form of the example embodiments described later. Note that the scope of application of techniques which are employed in the present example embodiment is not limited to the present example embodiment. That is, the techniques which are employed in the present example embodiment can be employed also in the other example embodiments included in the present disclosure, within a range in which no particular technical problem occurs. Moreover, techniques which are indicated in the drawings referred to for describing the present example embodiment can be employed also in the other example embodiments included in the present disclosure, within a range in which no particular technical problem occurs.

### (Configuration of Information Processing Device)

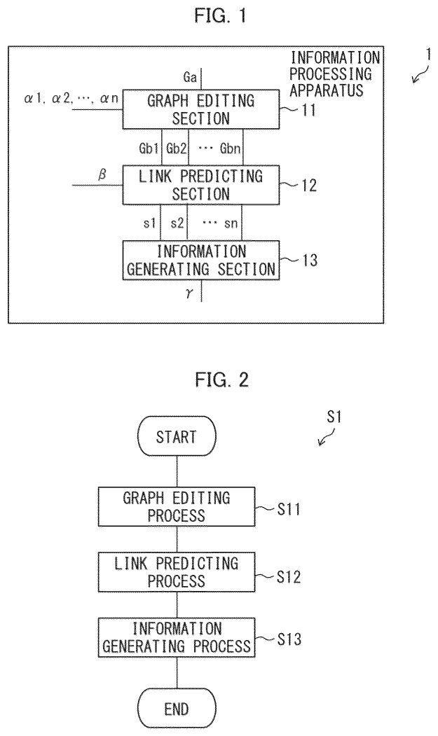

A configuration of an information processing apparatus 1 is described with reference to FIG. 1. FIG. 1 is a block diagram illustrating the configuration of the information processing apparatus 1.

The information processing apparatus 1 is an apparatus for generating, with use of a knowledge graph, information γ which indicates an influence that selection regarding at least one assumption α1, α2, . . . an has on a possibility that a conclusion β is derived. Note, here, that n is any natural number.

The information processing apparatus 1 includes a graph editing section 11, a link predicting section 12, and an information generating section 13, as illustrated in FIG. 1.

The graph editing section 11 is a means for generating at least one second knowledge graph Gb1, Gb2, . . . , Gbn by making editing corresponding to each of at least one assumption α1, α2, . . . , αn with respect to a first knowledge graph Ga. Note, here, that a second knowledge graph Gbi (i is a natural number of 1 or more but n or less) is a knowledge graph corresponding to an assumption αi, i.e., a knowledge graph obtained by making editing corresponding to the assumption αi with respect to the first knowledge graph Ga.

As an example, editing which corresponds to each assumption αi and which the graph editing section 11 makes with respect to the first knowledge graph Ga is editing in which a new link Lαi corresponding to the each assumption αi is added to the first knowledge graph Ga. As an example, editing which corresponds to each assumption αi and which the graph editing section 11 makes with respect to the first knowledge graph Ga is editing in which an existing link Lαi corresponding to the each assumption αi is deleted from the first knowledge graph Ga.

The link predicting section 12 is a means for calculating a score s1, s2, . . . , sn of a link Lβ1, Lβ2, . . . , Lβn with use of the link predicting technique. Note, here, that the link Lβ1, Lβ2, . . . , Lβn is a link corresponding to the conclusion β in each of at least one second knowledge graph Gb1, Gb2, . . . , Gbn which the graph editing section 11 has generated. A score si is a score of a link Lβi corresponding to the conclusion β in the second knowledge graph Gbi corresponding to the assumption αxi. Note that the link predicting section 12 may be configured to calculate the score s1, s2, . . . , sn of the link Lβ1, Lβ2, . . . , Lβn corresponding to the conclusion β in the second knowledge graph Gb1, Gb2, . . . , Gbn, with use of a model generated by machine learning. Note also that the link predicting section 12 may have a function of calculating, with use of the link predicting technique, a score s0 of a link Lβ0 corresponding to the conclusion β in the first knowledge graph Ga.

The information generating section 13 is a means for generating the information γ which indicates the influence that the selection regarding at least one assumption α1, α2, . . . , an has on the possibility that the conclusion β is derived, with reference to at least one score s1, s2, . . . , sn which the link predicting section 12 has calculated. The information which the information generating section 13 generates is, for example, a message which assists a user in making a decision on at least one assumption α1, α2, . . . , αn.

In a case where n≥2, the possibility that the conclusion β is derived varies depending on which one of a plurality of assumptions α1, α2, . . . , and αn is employed. In this case, the information generating section 13 preferably generates, as the information γ, information which indicates a difference in the possibility that the conclusion β is derived, the difference depending on which one of the plurality of assumptions α1, α2, . . . , and αn is employed. In a case where n=1, the possibility that the conclusion β is derived varies depending on whether or not a single assumption α1 is employed. In this case, the information generating section 13 preferably generates, as the information γ, information which indicates a difference in the possibility that the conclusion β is derived, the difference depending on whether or not the single assumption α1 is employed.

Note that the information generating section 13 may generate, as the information γ, the information which indicates the difference in the possibility that the conclusion β is derived, the difference depending on whether or not the single assumption α1 is employed. In this case, the information generating section 13 may generate the information γ with reference to the score s0 of the link Lβ0 corresponding to the conclusion β in the first knowledge graph Ga, in addition to the score s1 which the link predicting section 12 has calculated. In this case, the score s0 may be a score set in advance or may be a score which the link predicting section 12 has calculated with use of the link predicting technique.

### (Flow of Information Processing Method)

A flow of an information processing method S1 is described with reference to FIG. 2. FIG. 2 is a flowchart illustrating the flow of the information processing method S1.

The information processing method S1 is a method for generating, with use of a knowledge graph, information γ which indicates an influence that selection regarding at least one assumption α1, α2, . . . , αn has on a possibility that a conclusion β is derived.

The information processing method S1 includes a graph editing process S11, a link predicting process S12, and an information generating process S13, as illustrated in FIG. 2. The information processing method S1 is executed by, for example, the information processing apparatus 1.

The graph editing process S11 is a process for generating at least one second knowledge graph Gb1, Gb2, . . . , Gbn by making editing corresponding to each of at least one assumption α1, α2, . . . , αn with respect to a first knowledge graph Ga. Note, here, that a second knowledge graph Gbi is a knowledge graph corresponding to an assumption αi, i.e., a knowledge graph obtained by making editing corresponding to the assumption αi with respect to the first knowledge graph Ga. Note that the graph editing process S11 is executed by, for example, the graph editing section 11 of the information processing apparatus 1.

As an example, editing which corresponds to each assumption αi and which is made with respect to the first knowledge graph Ga in the graph editing process S11 is editing in which a new link Lαi corresponding to the each assumption αi is added to the first knowledge graph Ga. As an example, editing which corresponds to each assumption αi and which is made with respect to the first knowledge graph Ga in the graph editing process S11 is editing in which an existing link Lαi corresponding to the each assumption αi is deleted from the first knowledge graph Ga.

The link predicting process S12 is a process for calculating a score s1, s2, . . . , sn of a link Lβ1, Lβ2, . . . , Lβn with use of the link predicting technique. Note, here, that the link Lβ1, Lβ2, . . . , Lβn is a link corresponding to the conclusion β in each of at least one second knowledge graph Gb1, Gb2, . . . , Gbn which has been generated in the graph editing process S11. A score si is a score of a link Lβi corresponding to the conclusion β in the second knowledge graph Gbi corresponding to the assumption αi. In the link predicting process S12, a process of calculating, with use of the link predicting technique, a score s0 of a link Lβ0 corresponding to the conclusion β in the first knowledge graph Ga may be carried out. Note that the link predicting process S12 is executed by, for example, the link predicting section 12 of the information processing apparatus 1.

The information generating process S13 is a process for generating the information γ which indicates the influence that the selection regarding at least one assumption α1, α2, . . . , αn has on the possibility that the conclusion β is derived, with reference to at least one score s1, s2, . . . , sn which has been calculated in the link predicting process S12.

In a case where n≥2, the possibility that the conclusion β is derived varies depending on which one of a plurality of assumptions α1, α2, . . . , and αn is employed. In this case, in the information generating process S13, it is preferable to generate, as the information γ, information which indicates a difference in the possibility that the conclusion β is derived, the difference depending on which one of the plurality of assumptions α1, α2, . . . , and αn is employed. In a case where n=1, the possibility that the conclusion β is derived varies depending on whether or not a single assumption α1 is employed. In this case, in the information generating process S13, it is preferable to generate, as the information γ, information which indicates a difference in the possibility that the conclusion β is derived, the difference depending on whether or not the single assumption α1 is employed.

Note that, in the information generating process S13, the information which indicates the difference in the possibility that the conclusion β is derived, the difference depending on whether or not the single assumption α1 is employed, may be generated as the information γ. In this case, in the information generating process S13, the information γ may be generated with reference to the score s0 of the link Lβ0 corresponding to the conclusion β in the first knowledge graph Ga, in addition to the score s1 which has been calculated in the link predicting process S12. In this case, the score s0 may be a score set in advance or may be a score which has been calculated with use of the link predicting technique in the link predicting process S12.

### (Detailed Example 1 of Information Processing Method)

A first detailed example of the information processing method S1 is described with reference to FIG. 3. Here, exemplified is a knowledge graph which deals with issues concerning medical care, and described is a case where information γ which indicates a difference in a possibility that a conclusion β is derived, the difference depending on which one of two assumptions 1 and α2 is employed, is generated.

Used here is a first knowledge graph Ga which includes, as nodes, nodes that each represent a patient, nodes that each represent a gender, nodes that each represent an age, nodes that each represent a disease, nodes that each represent a symptom, and nodes that each represent a pharmaceutical. Further, used here is the first knowledge graph Ga which includes, as links, links that each represent a relation “gender”, links that each represent a relation “age”, links that each represent a relation “affection”, links that each represent a relation “side effect”, and links that each represent a relation “administration”. A part of the first knowledge graph Ga which part is directly linked with a node that represents a patient “patient A” is illustrated in an upper part of FIG. 3.

In this detailed example, considered is the possibility that the assumption α1 that a drug A is administered to the patient A and the assumption α2 that a drug B is administered to the patient A each derive the conclusion β that a symptom A appears in the patient A as a side effect.

In this case, a second knowledge graph Gb1 and a second knowledge graph Gb2 are each generated in the graph editing process S11. The second knowledge graph Gb1 is a graph obtained by adding, to the first knowledge graph Ga, a link Lα1 corresponding to the foregoing assumption α1. The second knowledge graph Gb2 is a graph obtained by adding, to the first knowledge graph Ga, a link Lα2 corresponding to the foregoing assumption α2. Note, here, that the link Lal corresponding to the foregoing assumption α1 is a link which connects the node that represents the patient “patient A” and a node that represents a pharmaceutical “drug A” and which represents the relation “administration”. Note also that the link Lα2 corresponding to the foregoing assumption α2 is a link which connects the node that represents the patient “patient A” and a node that represents a pharmaceutical “drug B” and which represents the relation “administration”. A part of the second knowledge graph Gb1 which part is directly linked with the node that represents the patient “patient A” is illustrated in a middle part of FIG. 3. A part of the second knowledge graph Gb2 which part is directly linked with the node that represents the patient “patient A” is illustrated in a lower part of FIG. 3.

In the link predicting process S12, a score s1 of a link Lβ1 corresponding to the foregoing conclusion β in the second knowledge graph Gb1 and a score s2 of a link Lβ2 corresponding to the foregoing conclusion β in the second knowledge graph Gb2 are each calculated. Note, here, that the links Lβ1 and Lβ2 each corresponding to the foregoing conclusion β are each a link which connects the node that represents the patient “patient A” and a node that represents a symptom “symptom A” and which represents the relation “side effect”. It is assumed here that 0.8 is calculated as the score s1 of the link Lβ1 in the second knowledge graph Gb1 and 0.2 is calculated as the score s2 of the link Lβ2 in the second knowledge graph Gb2.

In the information generating process S13, generated is information γ which indicates a difference in the possibility that the conclusion β is derived, the difference depending on which one of the foregoing two assumptions α1 and α2 is employed. As an example, generated is a message such as “Regarding the patient A, it is inferred that a possibility that administration of the drug B causes the symptom A as a side effect is lower than a possibility that administration of the drug A causes the symptom A as a side effect. Administration of the drug B is recommended.”

### (Detailed Example 2 of Information Processing Method)

A second detailed example of the information processing method S1 is described with reference to FIG. 4. Here, exemplified is a knowledge graph which deals with issues concerning medical care, and described is a case where information γ which indicates a difference in a possibility that a conclusion β is derived, the difference depending on which one of two assumptions α1 and α2 is employed, is generated.

Used here is a first knowledge graph Ga which includes, as nodes, nodes that each represent a patient, nodes that each represent a gender, nodes that each represent an age, nodes that each represent a disease, nodes that each represent a symptom, and nodes that each represent a pharmaceutical. Further, used here is the first knowledge graph Ga which includes, as links, links that each represent a relation “gender”, links that each represent a relation “age”, links that each represent a relation “affection”, links that each represent a relation “onset”, and links that each represent relation “administration”. A part of the first knowledge graph Ga which part is directly linked with a node that represents a patient “patient A” is illustrated in an upper part of FIG. 4.

In this detailed example, considered is the possibility that the assumption α1 that administration of a drug A to the patient A is stopped and the assumption α2 that administration of a drug B to the patient A is stopped each derive the conclusion β that a symptom A appears in the patient A as a symptom.

In this case, a second knowledge graph Gb1 and a second knowledge graph Gb2 are each generated in the graph editing process S11. The second knowledge graph Gb1 is a graph obtained by deleting, from the first knowledge graph Ga, a link Lα1 corresponding to the foregoing assumption α1. The second knowledge graph Gb2 is a graph obtained by deleting, from the first knowledge graph Ga, a link Lα2 corresponding to the foregoing assumption α2. Note, here, that the link Lα1 corresponding to the foregoing assumption α1 is a link which connects the node that represents the patient “patient A” and a node that represents a pharmaceutical “drug A” and which represents the relation “administration”. Note also that the link Lα2 corresponding to the foregoing assumption α2 is a link which connects the node that represents the patient “patient A” and a node that represents a pharmaceutical “drug B” and which represents the relation “administration”. A part of the second knowledge graph Gb1 which part is directly linked with the node that represents the patient “patient A” is illustrated in a middle part of FIG. 4. A part of the second knowledge graph Gb2 which part is directly linked with the node that represents the patient “patient A” is illustrated in a lower part of FIG. 4.

In the link predicting process S12, a score s1 of a link Lβ1 corresponding to the foregoing conclusion β in the second knowledge graph Gb1 and a score s2 of a link Lβ2 corresponding to the foregoing conclusion β in the second knowledge graph Gb2 are each calculated. The links Lβ1 and Lβ2 each corresponding to the foregoing conclusion β are each a link which connects the node that represents the patient “patient A” and a node that represents a symptom “symptom A” and which represents the relation “onset”. It is assumed here that 0.8 is calculated as the score s1 of the link Lβ1 in the second knowledge graph Gb1 and 0.3 is calculated as the score s2 of the link Lβ2 in the second knowledge graph Gb2.

In the information generating process S13, generated is information γ which indicates a difference in the possibility that the conclusion β is derived, the difference depending on which one of the foregoing two assumptions α1 and α2 is employed. As an example, generated is a message such as “Regarding the patient A, it is inferred that a possibility that stopping administration of the drug B causes onset of the symptom A is lower than a possibility that stopping administration of the drug A causes onset of the symptom A. Stopping administration of the drug B is recommended.”

### (Detailed Example 3 of Information Processing Method)

A third detailed example of the information processing method S1 is described with reference to FIG. 5. Here, exemplified is a knowledge graph which deals with issues concerning medical care, and described is a case where information γ which indicates a difference in a possibility that a conclusion β is derived, the difference depending on whether or not an assumption α1 is employed, is generated.

Used here is a first knowledge graph Ga which includes, as nodes, nodes that each represent a patient, nodes that each represent a gender, nodes that each represent an age, nodes that each represent a disease, nodes that each represent a prognosis, and nodes that each represent a pharmaceutical. Further, used here is the first knowledge graph Ga which includes, as links, links that each represent a relation “gender”, links that each represent a relation “age”, links that each represent a relation “affection”, links that each represent a relation “prognosis”, and links that each represent a relation “administration”. A part of the first knowledge graph Ga which part is directly linked with a node that represents a patient “patient A” is illustrated in an upper part of FIG. 5.

In this detailed example, considered is the possibility that the assumption α1 that a drug B is administered to the patient A derives the conclusion β that a prognosis of the patient A is death. It is assumed here that 0.8 is calculated in advance as a score s0 of a link Lβ0 corresponding to the foregoing conclusion β in the first knowledge graph Ga, i.e., the link Lβ0 which connects the node that represents the patient “patient A” and a node that represents a prognosis “death” and which represents the relation “prognosis”.

In this case, in the graph editing process S11, generated is a second knowledge graph Gb1 which is obtained by adding, to the first knowledge graph Ga, a link Lα1 corresponding to the foregoing assumption α1. Note, here, that the link Lα1 corresponding to the foregoing assumption α1 is a link which connects the node that represents the patient “patient A” and a node that represents a pharmaceutical “drug A” and which represents the relation “administration”. A part of the second knowledge graph Gb1 which part is directly linked with the node that represents the patient “patient A” is illustrated in a lower part of FIG. 5.

In the link predicting process S12, a score s1 of a link Lβ1 corresponding to the foregoing conclusion β in the second knowledge graph Gb1 is calculated. Note, here, that the link Lβ1 corresponding to the foregoing conclusion β is a link which connects the node that represents the patient “patient A” and the node that represents the prognosis “death” and which represents the relation “prognosis”. It is assumed here that 0.3 is calculated as the score s1 of the link Lβ1 in the second knowledge graph Gb1.

In the information generating process S13, generated is information γ which indicates a difference in the possibility that the conclusion β is derived, the difference depending on whether or not the foregoing one assumption α1 is employed. As an example, generated is a message such as “Regarding the patient A, it is inferred that a possibility that administration of the drug A results in a prognosis of death is lower than a possibility that no administration of the drug A results in the prognosis of death. Administration of the drug A is recommended.”

### (Other Detailed Examples)

The scope of application of the information processing method S1 is not limited to knowledge graphs which deal with issues regarding medical care.

For example, the information processing method S1 can also be applied to a knowledge graph which deals with issues concerning corporate personnel affairs. The knowledge graph which deals with the issues concerning the corporate personnel affairs includes, as nodes, for example, nodes that each represent an employee, nodes that each represent a gender, nodes that each represent an age, nodes that each represent the length of the period of employment (for example, a node that represents the length of the period of employment “less than 10 years”, a node that represents the length of the period of employment “10 years or more”, and the like), nodes that each represent a department (for example, a node that represents a department “accounts department”, a node that represents a department “general affairs department”, and the like), and the like. Further, the knowledge graph includes, as links, for example, links that each represent a relation “gender”, links that each represent a relation “age”, links that each represent a relation “the length of the period of employment”, links that each represent a relation “assignment”, and the like. Use of such a knowledge graph makes it possible to generate information which indicates what difference arises in a possibility that a conclusion that an employee A continues to work for 10 years or more is derived, depending on an assumption employed (for example, whether an assumption that the employee A is assigned to the accounts department is employed or whether an assumption that the employee A is assigned to the general affairs department is employed).

Alternatively, the information processing method S1 can also be applied to a knowledge graph which deals with issues concerning product development. The knowledge graph which deals with the issues concerning the product development includes, as nodes, for example, nodes that each represent a product, nodes that each represent a function, nodes that each represent a quantity (for example, a node that represents a quantity “less than 1,000”, a node that represents a quantity “1,000 or more”, and the like), and the like. Further, the knowledge graph includes, as links, links that each represent a relation “implementation”, links that each represent a relation “sales quantity”, and the like. Use of such a knowledge graph makes it possible to generate information which indicates what difference arises in a possibility that a conclusion that the sales quantity of a product A is 1,000 or more is derived, depending on an assumption employed (for example, whether an assumption that a function A is implemented in the product A is employed or whether an assumption that a function B is implemented in the product A is employed).

### Second Example Embodiment

The following description will discuss a second example embodiment, which is an example of an embodiment of the present invention, in detail, with reference to the drawings. The same reference signs are given to constituent elements having the same functions as those of the constituent elements described in the foregoing example embodiment, and descriptions thereof are omitted as appropriate. Note that the scope of application of techniques which are employed in the present example embodiment is not limited to the present example embodiment. That is, the techniques which are employed in the present example embodiment can be employed also in the other example embodiments included in the present disclosure, within a range in which no particular technical problem occurs. Moreover, techniques indicated in the drawings referred to for describing the present example embodiment can be employed also in the other example embodiments included in the present disclosure, within a range in which no particular technical problem occurs.

A configuration of an information processing apparatus 1A is described with reference to FIG. 6. FIG. 6 is a block diagram illustrating the configuration of the information processing apparatus 1A.

The information processing apparatus 1A is obtained by adding a user interface (UI) section 14 to the information processing apparatus 1 illustrated in FIG. 1. Since a graph editing section 11, a link predicting section 12, and an information generating section 13 of the information processing apparatus 1A are the same as the graph editing section 11, the link predicting section 12, and the information generating section 13, respectively, of the information processing apparatus 1 illustrated in FIG. 1, descriptions thereof are omitted here.

The UI section 14 causes an information input/output screen 2 to be displayed on a display connected to or embedded in the information processing apparatus 1A. The information input/output screen 2 is used in order for a user to input an assumption α1, α2, . . . , αn and a conclusion β as described above into the information processing apparatus 1A or in order for the information processing apparatus 1A to present information γ as described above to the user.

FIG. 7 is a plan view illustrating a detailed example of the information input/output screen 2. The information input/output screen 2 illustrated in FIG. 7 includes four regions 21 to 24.

The region 21 is used in order for the user to input the assumption α1. In this region 21, a pull-down list 21a for selecting a patient and a pull-down list 21b for selecting a pharmaceutical are provided. The region 22 is used in order for the user to input the assumption α2. In this region 22, a pull-down list 22a for selecting a patient and a pull-down list 22b for selecting a pharmaceutical are provided. The region 23 is used in order for the user to input the conclusion β. In this region 23, a pull-down list 23a for selecting a patient and a pull-down list 23b for selecting a symptom are provided. The pull-down list 21a in the region 21, the pull-down list 22a in the region 22, and the pull-down list 23a in the region 23 are in synchronization with each other. In a case where a certain patient is selected in one of the pull-down lists, the same patient is selected in the other of the pull-down lists.

The information processing apparatus 1A carries out an information processing method S1 as described above with respect to the assumption α1 which has been inputted with use of the region 21, the assumption α2 which has been inputted with use of the region 22, and the conclusion β which has been inputted with use of the region 23. As a result, the information processing apparatus 1A generates the information γ which indicates what difference arises in a possibility that the conclusion β inputted by the user with use of the region 23 is derived, depending on which one of the assumptions α1 and α2 is employed.

The region 24 is used to present, to the user, the information γ which the information processing apparatus 1A has generated. In an example illustrated in FIG. 7, a message “Regarding a patient A, it is inferred that a possibility that administration of a drug B causes a symptom A as a side effect is lower than a possibility that administration of a drug A causes the symptom A as a side effect. Administration of the drug B is recommended.” is presented as the information γ.

### [Software Implementation Example]

Some or all of the functions of the information processing apparatus 1, 1A (hereinafter also referred to as “each apparatus”) may be implemented by hardware such as an integrated circuit (IC chip), or may be implemented by software.

In the latter case, the each apparatus is realized by, for example, a computer that executes the instructions of a program that is software realizing the functions. FIG. 8 illustrates an example of such a computer (hereinafter, referred to as “computer C”). FIG. 8 is a block diagram illustrating a hardware configuration of the computer C which functions as the each apparatus.

The computer C includes at least one processor C1 and at least one memory C2. In the memory C2, an information processing program P for causing the computer C to operate as each means is recorded. In the computer C, the processor C1 retrieves the information processing program P from the memory C2 and executes the information processing program P, so that the function of each section (means) is implemented.

The processor C1 can be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. The memory C2 can be, for example, a flash memory, a hard disk drive (HDD), a solid state drive (SSD), or a combination of these.

Note that the computer C may further include a random access memory (RAM) in which the information processing program P is loaded in a case where the information processing program P is executed and in which various kinds of data are temporarily stored. The computer C may further include a communication interface via which the computer C transmits and receives data to and from another apparatus. The computer C may further include an input/output interface via which the computer C is connected to an input/output apparatus such as a keyboard, a mouse, a display, and a printer.

The information processing program P can be recorded in a non-transitory tangible recording medium M which is readable by the computer C. Such a recording medium M can be, for example, a tape, a disk, a card, a semiconductor memory, a programmable logic circuit, or the like. The computer C can obtain the information processing program P via the recording medium M. The information processing program P can be transmitted via a transmission medium. The transmission medium can be, for example, a communications network, a broadcast wave, or the like. The computer C can obtain the information processing program P also via such a transmission medium.

### [Additional Remark 1]

The present disclosure includes techniques described in supplementary notes below. Note, however, that the present invention is not limited to the techniques described in the supplementary notes below, but may be altered in various ways by a skilled person within the scope of the claims.

### (Supplementary Note 1)

An information processing apparatus including:
a graph editing means for generating at least one second knowledge graph by making editing corresponding to each of at least one assumption with respect to a first knowledge graph which includes nodes that each represent an object and links that each represent a relation between objects;
a link predicting means for calculating, with use of a link predicting technique, a score of a link corresponding to a conclusion in each of the at least one second knowledge graph which has been generated by the graph editing means; and
an information generating means for generating information which indicates an influence that selection regarding the at least one assumption has on a possibility that the conclusion is derived, with reference to at least one score which has been calculated by the link predicting means.

### (Supplementary Note 2)

The information processing apparatus described in Supplementary note 1, wherein
the graph editing means generates the at least one second knowledge graph by adding a new link corresponding to the each of the at least one assumption to the first knowledge graph or deleting an existing link corresponding to the each of the at least one assumption from the first knowledge graph.

### (Supplementary Note 3)

The information processing apparatus described in Supplementary note 1 or 2, wherein:
the graph editing means generates a plurality of second knowledge graphs by making editing corresponding to each of a plurality of assumptions with respect to the first knowledge graph; and
the information generating means generates information which indicates a difference in the possibility that the conclusion is derived, the difference depending on which one of the plurality of assumptions is employed.

### (Supplementary Note 4)

The information processing apparatus described in any one of Supplementary note 1 to 3, wherein:
the graph editing means generates a single second knowledge graph by making editing corresponding to a single assumption with respect to the first knowledge graph; and
the information generating means generates information which indicates a difference in the possibility that the conclusion is derived, the difference depending on whether or not the single assumption is employed.

### (Supplementary Note 5)

The information processing apparatus described in Supplementary note 4, wherein
the information generating means generates the information with: reference to a of a link corresponding to the conclusion in the first knowledge graph, in addition to a score of a link corresponding to the conclusion in the single second knowledge graph.

### (Supplementary Note 6)

The information processing apparatus described in any one of Supplementary notes 1 to 5, wherein:
the first knowledge graph is a knowledge graph which deals with issues concerning medical care;
the first knowledge graph includes, as the nodes, at least one selected from the group consisting of nodes that each represent a patient, nodes that each represent a gender, nodes that each represent an age, nodes that each represent a disease, nodes that each represent a symptom, nodes that each represent a prognosis, and nodes that each represent a pharmaceutical; and the first knowledge graph includes, as the links, at least one selected from the group consisting of links that each represent a relation “gender”, links that each represent a relation “age”, links that each represent a relation “affection”, links that each represent a relation “onset”, links that each represent a relation “side effect”, links that each represent a relation “prognosis”, and links that each represent a relation “administration”.

### (Supplementary Note 7)

The information processing apparatus described in Supplementary note 6, wherein
the editing corresponding to the at least one assumption includes editing in which a new link that connects a node representing a specific patient and a node representing a specific agent and that represents a relation “medication” is added or editing in which an existing link that connects the node representing the specific patient and the node representing the specific agent and that represents the relation “medication” is deleted.

### (Supplementary Note 8)

The information processing apparatus described in Supplementary note 6 or 7, wherein
the link corresponding to the conclusion includes: a link that connects a node representing a specific patient and a node representing a specific symptom and that represents a relation “side effect”; a link that connects the node representing the specific patient and the node representing the specific symptom and that represents a relation “symptom”; or a link that connects the node representing the specific patient and a node representing a specific prognosis and that represents a relation “prognosis”.

### (Supplementary Note 9)

An information processing method including:
a graph editing process of generating at least one second knowledge graph by making editing corresponding to each of at least one assumption with respect to a first knowledge graph which includes nodes that each represent an object and links that each represent a relation between objects;
a link predicting process of calculating, with use of a link predicting technique, a score of a link corresponding to a conclusion in each of the at least one second knowledge graph which has been generated in the graph editing process; and
an information generating process of generating information which indicates an influence that selection regarding the at least one assumption has on a possibility that the conclusion is derived, with reference to at least one score which has been calculated in the link predicting process,
the graph editing process, the link predicting process, and the information generating process being carried out by at least one processor.

### (Supplementary Note 10)

An information processing program for causing at least one processor to execute:
a graph editing process of generating at least one second knowledge graph by making editing corresponding to each of at least one assumption with respect to a first knowledge graph which includes nodes that each represent an object and links that each represent a relation between objects;
a link predicting process of calculating, with use of a link predicting technique, a score of a link corresponding to a conclusion in each of the at least one second knowledge graph which has been generated in the graph editing process; and
an information generating process of generating information which indicates an influence that selection regarding the at least one assumption has on a possibility that the conclusion is derived, with reference to at least one score which has been calculated in the link predicting process.

### (Supplementary Note 11)

The information processing method described in Supplementary note 9, wherein
in the graph editing process, the at least one processor generates the at least one second knowledge graph by adding a new link corresponding to the each of the at least one assumption to the first knowledge graph or deleting an existing link corresponding to the each of the at least one assumption from the first knowledge graph.

### (Supplementary Note 12)

The information processing method described in Supplementary note 9 or 11, wherein:
in the graph editing process, the at least one processor generates a plurality of second knowledge graphs by making editing corresponding to each of a plurality of assumptions with respect to the first knowledge graph; and
in the information generating process, the at least one processor generates information which indicates a difference in the possibility that the conclusion is derived, the difference depending on which one of the plurality of assumptions is employed.

### (Supplementary Note 13)

The information processing method described in any one of Supplementary notes 9, 11, and 12, wherein:
in the graph editing process, the at least one processor generates a single second knowledge graph by making editing corresponding to a single assumption with respect to the first knowledge graph; and
in the information generating process, the at least one processor generates information which indicates a difference in the possibility that the conclusion is derived, the difference depending on whether or not the single assumption is employed.

### (Supplementary Note 14)

The information processing method described in Supplementary note 13, wherein
in the information generating process, the at least one processor generates the information with reference to a score of a link corresponding to the conclusion in the first knowledge graph, in addition to a score of a link corresponding to the conclusion in the single second knowledge graph.

### (Supplementary Note 15)

The information processing method described in any one of Supplementary notes 9 and 11 to 14, wherein:
the first knowledge graph is a knowledge graph which deals with issues concerning medical care;
the first knowledge graph includes, as the nodes, at least one selected from the group consisting of nodes that each represent a patient, nodes that each represent a gender, nodes that each represent an age, nodes that each represent a disease, nodes that each represent a symptom, nodes that each represent a prognosis, and nodes that each represent a pharmaceutical; and
the first knowledge graph includes, as the links, at least one selected from the group consisting of links that each represent a relation “gender”, links that each represent a relation “age”, links that each represent a relation “affection”, links that each represent a relation “onset”, links that each represent a relation “side effect”, links that each represent a relation “prognosis”, and links that each represent a relation “administration”.

### (Supplementary Note 16)

The information processing method described in Supplementary note 15, wherein
the editing corresponding to the at least one assumption includes editing in which a new link that connects a node representing a specific patient and a node representing a specific agent and that represents a relation “medication” is added or editing in which an existing link that connects the node representing the specific patient and the node representing the specific agent and that represents the relation “medication” is deleted.

### (Supplementary Note 17)

The information processing method described in Supplementary note 15 or 16, wherein
the link corresponding to the conclusion includes: a link that connects a node representing a specific patient and a node representing a specific symptom and that represents a relation “side effect”; a link that connects the node representing the specific patient and the node representing the specific symptom and that represents a relation “symptom”; or a link that connects the node representing the specific patient and a node representing a specific prognosis and that represents a relation “prognosis”.

### (Supplementary Note 18)

The information processing program described in Supplementary note 10, wherein
the information processing program causes the at least one processor to
in the graph editing process, generate the at least one second knowledge graph by adding a new link corresponding to the each of the at least one assumption to the first knowledge graph or deleting an existing link corresponding to the each of the at least one assumption from the first knowledge graph.

### (Supplementary Note 19)

The information processing program described in Supplementary note 10 or 18, wherein
the information processing program causes the at least one processor to:
in the graph editing process, generate a plurality of second knowledge making editing graphs by corresponding to each of a plurality of assumptions with respect to the first knowledge graph; and
in the information generating process, generate information which indicates a difference in the possibility that the conclusion is derived, the difference depending on which one of the plurality of assumptions is employed.

### (Supplementary Note 20)

The information processing program described in any one of Supplementary notes 10, 18, and 19, wherein
the information processing program causes the at least one processor to:
in the graph editing process, generate a single second knowledge graph by making editing corresponding to a single assumption with respect to the first knowledge graph; and
in the information generating process, generate information which indicates a difference in the possibility that the conclusion is derived, the difference depending on whether or not the single assumption is employed.

### (Supplementary Note 21)

The information processing program described in Supplementary note 20, wherein
the information processing program causes the at least one processor to
in the information generating process, generate the information with reference to a score of a link corresponding to the conclusion in the first knowledge graph, in addition to a score of a link corresponding to the conclusion in the single second knowledge graph.

### (Supplementary Note 22)

The information processing program described in any one of Supplementary notes 10 and 18 to 21, wherein:
the first knowledge graph is a knowledge graph which deals with issues concerning medical care;
the first knowledge graph includes, as the nodes, at least one selected from the group consisting of nodes that each represent a patient, nodes that each represent a gender, nodes that each represent an age, nodes that each represent a disease, nodes that each represent a symptom, nodes that each represent a prognosis, and nodes that each represent a pharmaceutical; and
the first knowledge graph includes, as the links, at least one selected from the group consisting of links that each represent a relation “gender”, links that each represent a relation “age”, links that each represent a relation “affection”, links that each represent a relation “onset”, links that each represent a relation “side effect”, links that each represent a relation “prognosis”, and links that each represent a relation “administration”.

### (Supplementary Note 23)

The information processing program described in Supplementary note 22, wherein
the editing corresponding to the at least one assumption includes editing in which a new link that connects a node representing a specific patient and a node representing a specific agent and that represents a relation “medication” is added or editing in which an existing link that connects the node representing the specific patient and the node representing the specific agent and that represents the relation “medication” is deleted.

### (Supplementary Note 24)

The information processing program described in Supplementary note 22 or 23, wherein
the link corresponding to the conclusion includes: a link that connects a node representing a specific patient and a node representing a specific symptom and that represents a relation “side effect”; a link that connects the node representing the specific patient and the node representing the specific symptom and that represents a relation “symptom”; or a link that connects the node representing the specific patient and a node representing a specific prognosis and that represents a relation “prognosis”.

### (Supplementary Note 25)

The information processing apparatus described in any one of Supplementary notes 1 to 8, wherein
the link predicting means calculates the score with use of a model which has been generated by machine learning.

### (Supplementary Note 26)

The information processing apparatus described in any one of Supplementary notes 1 to 8 and 25, wherein
the information is a message which assists a user in making a decision on the at least one assumption.

### (Supplementary Note 27)

The information processing method described in any one of Supplementary notes 9 and 11 to 17, wherein
in the link predicting process, the score is calculated with use of a model which has been generated by machine learning.

### (Supplementary Note 28)

The information processing method described in any one of Supplementary notes 9, 11 to 17, and 27, wherein
the information is a message which assists a user in making a decision on the at least one assumption.

### (Supplementary Note 29)

The information processing program described in any one of Supplementary notes 10 and 18 to 24, wherein
in the link predicting process, the score is calculated with use of a model which has been generated by machine learning.

### (Supplementary Note 30)

The information processing program described in any one of Supplementary notes 10, 18 to 24, and 29, wherein the information is a message which assists a user in making a decision on the at least one assumption.

### [Additional Remark 2]

The present disclosure includes techniques described in supplementary notes below. Note, however, that the present invention is not limited to the techniques described in the supplementary notes below, but may be altered in various ways by a skilled person within the scope of the claims.

### (Supplementary Note 1)

An information processing apparatus including:
at least one processor,
the at least one processor executing:
a graph editing process of generating at least one second knowledge graph by making editing corresponding to each of at least one assumption with respect to a first knowledge graph which includes nodes that each represent an object and links that each represent a relation between objects;
a link predicting process of calculating, with use of a link predicting technique, a score of a link corresponding to a conclusion in each of the at least one second knowledge graph which has been generated in the graph editing process; and
an information generating process of generating information which indicates an influence that selection regarding the at least one assumption has on possibility that the conclusion is derived, with reference to at least one score which has been calculated in the link predicting process.

### (Supplementary Note 2)

The information processing apparatus described in Supplementary note 1, wherein
in the graph editing process, the at least one processor generates the at least one second knowledge graph by adding a new link corresponding to the each of the at least one assumption to the first knowledge graph or deleting an existing link corresponding to the each of the at least one assumption from the first knowledge graph.

### (Supplementary Note 3)

The information processing apparatus described in Supplementary note 1 or 2, wherein:
in the graph editing process, the at least one processor generates a plurality of second knowledge graphs by making editing corresponding to each of a plurality of assumptions with respect to the first knowledge graph; and
in the information generating process, the at least one processor generates information which indicates a difference in the possibility that the conclusion is derived, the difference depending on which one of the plurality of assumptions is employed.

### (Supplementary Note 4)

The information processing apparatus described in any one of Supplementary notes 1 to 3, wherein:
in the graph editing process, the at least one processor generates a single second knowledge graph by making editing corresponding to a single assumption with respect to the first knowledge graph; and
in the information generating process, the at least one processor generates information which indicates a difference in the possibility that the conclusion is derived, the difference depending on whether or not the single assumption is employed.

### (Supplementary Note 5)

The information processing apparatus described in Supplementary note 4, wherein
in the information generating process, the at least one processor generates the information with reference to a score of a link corresponding to the conclusion in the first knowledge graph, in addition to a single score which has been calculated in the link predicting process.

### (Supplementary Note 6)

The information processing apparatus described in any one of Supplementary notes 1 to 5, wherein:
the first knowledge k graph is a knowledge graph which deals with issues concerning medical care;
the first knowledge graph includes, as the nodes, at least one selected from the group consisting of nodes that each represent a patient, nodes that each represent a gender, nodes that each represent an age, nodes that each represent a disease, nodes that each represent a symptom, nodes that each represent a prognosis, and nodes that each represent a pharmaceutical; and
the first knowledge graph includes, as the links, at least one selected from the group consisting of links that each represent a relation “gender”, links that each represent a relation “age”, links that each represent a relation “affection”, links that each represent a relation “onset”, links that each represent a relation “side effect”, links that each represent a relation “prognosis”, and links that each represent a relation “administration”.

### (Supplementary Note 7)

The information processing apparatus described in Supplementary note 6, wherein
the editing corresponding to the at least one assumption includes editing in which a new link that connects a node representing a specific patient and a node representing a specific agent and that represents a relation “medication” is added or editing in which an existing link that connects the node representing the specific patient and the node representing the specific agent and that represents the relation “medication” is deleted.

### (Supplementary Note 8)

The information processing apparatus described in Supplementary note 6 or 7, wherein
the link corresponding to the conclusion includes: a link that connects a node representing a specific patient and a node representing a specific symptom and that represents a relation “side effect”; a link that connects the node representing the specific patient and the node representing the specific symptom and that represents a relation “symptom”; or a link that connects the node representing the specific patient and a node representing a specific prognosis and that represents a relation “prognosis”.

(Supplementary Note 9)

The information processing apparatus described in any one of Supplementary notes 1 to 8, wherein
in the link predicting process, the at least one processor calculates the score with use of a model which has been generated by machine learning.

(Supplementary Note 10)

The information processing apparatus described in any one of Supplementary notes 1 to 9, wherein
the information is a message which assists a user in making a decision on the at least one assumption.

### REFERENCE SIGNS LIST

1, 1A Information processing apparatus
2 Information input/output screen
11 Graph editing section (graph editing means)
12 Link predicting section (link predicting means)
13 Information generating section (information generating means)
14 UI section
21, 22, 23, 24 Region
21a, 21b, 22a, 22b, 23a, 23b Pull-down list
C1 Processor
C2 Memory
Ga First knowledge graph
Gbi Second knowledge graph
Lαi, Lβi Link
si Score
S1 Information processing method
S11 Graph editing process
S12 Link predicting process
S13 Information generating process
αi Assumption
β Conclusion
γ Information

1. An information processing apparatus comprising
at least one processor,
the at least one processor executing:
a graph editing process of generating at least one second knowledge graph by making editing corresponding to each of at least one assumption with respect to a first knowledge graph which includes nodes that each represent an object and links that each represent a relation between objects;
a link predicting process of calculating, with use of a link predicting technique, a score of a link corresponding to a conclusion in each of the at least one second knowledge graph which has been generated in the graph editing process; and
an information generating process of generating information which indicates an influence that selection regarding the at least one assumption has on a possibility that the conclusion is derived, with reference to at least one score which has been calculated in the link predicting process.

2. The information processing apparatus as set forth in claim 1, wherein
in the graph editing process, the at least one processor generates the at least one second knowledge graph by adding a new link corresponding to the each of the at least one assumption to the first knowledge graph or deleting an existing link corresponding to the each of the at least one assumption from the first knowledge graph.

3. The information processing apparatus as set forth in claim 1, wherein:
in the graph editing process, the at least one processor generates plurality of second knowledge graphs by making editing corresponding to each of a plurality of assumptions with respect to the first knowledge graph; and
in the information generating process, the at least one processor generates information which indicates a difference in the possibility that the conclusion is derived, the difference depending on which one of the plurality of assumptions is employed.

4. The information processing apparatus as set forth in claim 1, wherein:
in the graph editing process, the at least one processor generates a single second knowledge graph by making editing corresponding to a single assumption with respect to the first knowledge graph; and
in the information generating process, the at least one processor generates information which indicates a difference in the possibility that the conclusion is derived, the difference depending on whether or not the single assumption is employed.

5. The information processing apparatus as set forth in claim 4, wherein
in the information generating process, the at least one processor generates the information with reference to a score of a link corresponding to the conclusion in the first knowledge graph, in addition to a score of a link corresponding to the conclusion in the single second knowledge graph.

6. The information processing apparatus as set forth in claim 1, wherein:
the first knowledge graph is a knowledge graph which deals with issues concerning medical care;
the first knowledge graph includes, as the nodes, at least one selected from the group consisting of nodes that each represent a patient, nodes that each represent a gender, nodes that each represent an age, nodes that each represent a disease, nodes that each represent a symptom, nodes that each represent a prognosis, and nodes that each represent a pharmaceutical; and
the first knowledge graph includes, as the links, at least one selected from the group consisting of links that each represent a relation “gender”, links that each represent a relation “age”, links that each represent a relation “affection”, links that each represent a relation “onset”, links that each represent a relation “side effect”, links that each represent a relation “prognosis”, and links that each represent a relation “administration”.

7. The information processing apparatus as set forth in claim 1, wherein
in the link predicting process, the at least one processor calculates the score with use of a model which has been generated by machine learning.

8. The information processing apparatus as set forth in claim 1, wherein
the information is a message which assists a user in making a decision on the at least one assumption.

9. An information processing method comprising:
a graph editing process of generating at least one second knowledge graph by making editing corresponding to each of at least one assumption with respect to a first knowledge graph which includes nodes that each represent an object and links that each represent a relation between objects;
a link predicting process of calculating, with use of a link predicting technique, a score of a link corresponding to a conclusion in each of the at least one second knowledge graph which has been generated in the graph editing process; and
an information generating process of generating information which indicates an influence that selection regarding the at least one assumption has on a possibility that the conclusion is derived, with reference to at least one score which has been calculated in the link predicting process,
the graph editing process, the link predicting process, and the information generating process being carried out by at least one processor.

10. A non-transitory recording medium in which an information processing program is recorded,
the information processing program causing at least one processor to execute:
a graph editing process of generating at least one second knowledge graph by making editing corresponding to each of at least one assumption with respect to a first knowledge graph which includes nodes that each represent an object and links that each represent a relation between objects;
a link predicting process of calculating, with use of a link predicting technique, a score of a link corresponding to a conclusion in each of the at least one second knowledge graph which has been generated in the graph editing process; and
an information generating process of generating information which indicates an influence that selection regarding the at least one assumption has on a possibility that the conclusion is derived, with reference to at least one score which has been calculated in the link predicting process.
